(19) United States
(12) Patent Application Publication
(10) Pub. No.: US 2026/0110401 A1
(43) Pub. Date: Apr. 23, 2026

(54) TANK INCLUDING A CORNER ANCHOR ELEMENT

(71) Applicant: GAZTRANSPORT ET TECHNIGAZ, Saint-Remy-Les-Chevreuse (FR)

(72) Inventors: Fabien Pesquet, Saint-Remy-Les-Chevreuse (FR); Erwan Michaut, Saint-Remy-Les-Chevreuse (FR); Camille Gourmelen, Saint-Remy-Les-Chevreuse (FR); Thomas Pillot, Saint-Remy-Les-Chevreuse (FR); Rémy Prioleau, Saint-Remy-Les-Chevreuse (FR); Gaël Tos, Saint-Remy-Les-Chevreuse (FR); Thomas Conejero, Saint-Remy-Les-Chevreuse (FR)

(73) Assignee: GAZTRANSPORT ET TECHNIGAZ, Saint-Remy-Les-Chevreuse (FR)

(21) Appl. No.: 19/364,057

(22) Filed: Oct. 21, 2025

(30) Foreign Application Priority Data
Oct. 21, 2024 (FR) 2411429

(51) Int. Cl. F17C 3/02; F17C 13/08

(52) U.S. Cl. CPC F17C 3/02; F17C 13/082; F17C 2205/0103; F17C 2209/232; F17C 2223/0153; F17C 2270/0105

(57) ABSTRACT

Described is a sealed and thermally-insulating tank for storing liquefied gas which includes first and second tank walls joined at an edge, first and second primary thermally-insulating barrier supported by a support, and an anchor element. The anchor element includes a corner anchor rod extending in a direction that crosses the direction of the edge in an extension plane inclined at a non-zero angle relative to each of the first and second tank walls. The anchor element also includes an anchor bar anchored in the supporting structure and extending in a plane perpendicular to the direction of the anchor rod. A first end of the anchor rod cooperates with the anchor bar, and a second end of the anchor rod cooperates with an anchor strip to transmit a traction force between the anchor strip and a support.

### TECHNICAL FIELD

The invention relates to the field of sealed and thermally-insulating tanks integrated into a supporting structure to contain a cold fluid and in particular membrane tanks for containing liquefied gases and relates in particular to mechanical anchor devices usable in a wall of such a tank.

The invention relates in particular to the field of sealed and thermally-insulating tanks for storing and/or transporting liquefied gas at a low temperature such as tanks for transporting liquefied natural gas (LNG) at approximately −162° C. at atmospheric pressure, liquid hydrogen (LH₂) at −253° C. at atmospheric pressure, ammonia (NH₃) at −30° C. at atmospheric pressure or liquefied petroleum gas (LPG) at a temperature between −50° C. and 0° C. for example. These tanks can be installed on land or on a floating structure.

In the case of a floating structure the tank can be intended to transport liquefied gas or to receive liquefied gas serving as fuel for the propulsion of the floating structure.

### TECHNOLOGICAL BACKGROUND

Known sealed and thermally-insulating tanks intended to receive a liquefied gas, in particular liquefied natural gas (LNG) or liquefied petroleum gas (LPG), are described for example in the documents FR2102974 and FR2781557.

These tanks can be self-supporting or not.

These tanks include one or two sealing membranes associated with one or two thermally-insulating barriers.

Furthermore these tanks are adapted to store LPG or LNG but not to store liquid hydrogen at −253° C. at atmospheric pressure.

### SUMMARY OF THE INVENTION

One idea behind the invention is to provide a tank for storing a liquefied gas.

In particular the proposed tank enables an additional thermally-insulating and sealed layer to be added easily to the walls of a pre-existing tank for storing a liquefied gas. In particular it enables conversion of a tank adapted to store LNG or LPG whether it be a self-supporting tank or a membrane tank into a tank adapted to contain liquid products at temperatures lower than the liquefaction temperature of LNG or LPG.

The tank according to the invention is advantageously adapted to store liquefied gases such as liquefied hydrogen or argon facilitating the addition of one or more thermally-insulating and sealed layers.

In other words the aim is to improve the thermal insulation performance of sealed and thermally-insulating tanks.

In one embodiment the invention provides a sealed and thermally-insulating tank intended to store liquefied gas, which tank includes a first tank wall and a second tank wall joining at the level of an edge and respectively extending in a first median plane and a second median plane inclined relative to one another so as to form at the level of the junction between the first and second tank walls a corner zone,
the first tank wall including in a first direction of thickness of the first tank wall: a first thermally-insulating barrier and a first sealed membrane supported by the first thermally-insulating barrier,
the second tank wall including in a second direction of thickness of the second tank wall: a second thermally-insulating barrier and a second sealed membrane supported by the second thermally-insulating barrier,
the first and second sealed membranes being fixed in sealed manner to a corner anchor strip along said edge and said tank also including a corner anchor element including:
a corner anchor rod extending in a direction that crosses the direction of said edge formed between the first and second walls in an extension plane passing through said edge inclined at a non-zero angle relative to each of said first and second tank walls,
an anchor bar anchored to a support, the anchor bar extending in a plane perpendicular to the direction of the anchor rod,
a first end of the anchor rod cooperating with said anchor bar and a second end of the anchor rod cooperating with the anchor strip to transmit a traction force between the anchor strip and the support.

In one embodiment the corner anchor element further includes a blocking end part that cooperates with the second end of the anchor rod to block the second end of the anchor rod on the corner anchor strip.

In one embodiment said anchor bar has a central part of polygonal or circular section.

In one embodiment the anchor bar is formed of a hollow external wall.

In one embodiment the hollow external wall of the anchor bar contains a thermally-insulating packing material.

In one embodiment the anchor bar is solid and formed in one piece.

In one embodiment a central part of the anchor bar includes an orifice passing through it that receives said anchor rod.

In one embodiment the first end of the anchor rod extends beyond the anchor bar by less than 3 centimetres in such a manner as to prevent contact with the support.

In one embodiment the anchor rod is at least partially threaded and fixed against the anchor bar by a nut welded to the anchor bar on an exterior face of the anchor bar facing the support.

In one embodiment the nut is a knuckle nut.

In one embodiment the corner angle element includes a corner abutment part having two lateral faces adapted to be pressed against the corner anchor strip and a main face through which the second end of the anchor rod projects.

In one embodiment the second end of the anchor rod receives a blocking nut that axially blocks the corner abutment part and a sealed protective cover that covers said second end entirely.

In one embodiment the second end of the anchor rod further receives at least one compressible clamping washer disposed between the blocking nut and the corner abutment part.

In one embodiment the second end of the anchor rod further receives a spacer including:
a plane base disposed between the blocking nut and said at least one compressible clamping washer, and
a sleeve that receives the anchor rod and passes through a central opening in said at least one compressible clamping washer.

The support can be implemented in numerous ways. In one embodiment the support is part of a steel or concrete supporting structure. In one embodiment the support is part of a thermally-insulating barrier. In one embodiment the support is part of a membrane.

In one embodiment each of the first and second tank walls further includes an underlying sealed membrane and an underlying thermally-insulating barrier disposed between the underlying sealed membrane and the supporting structure, the support being an element of the underlying sealed membrane.

In one embodiment the support is a metal angle iron of the underlying sealed membrane.

In one embodiment the underlying sealed membrane is a primary sealed membrane, each of the first and second tank walls further including a secondary sealed membrane disposed between the primary sealed membrane and the supporting structure, the underlying thermally-insulating barrier including a secondary thermally-insulating barrier disposed between the secondary sealed membrane and the supporting structure and a primary thermally-insulating barrier disposed between the secondary sealed membrane and the primary sealed membrane.

In one embodiment the first and second walls form between them in the extension plane of the anchor rod a tank corner, the direction of the anchor rod dividing this tank corner into two equal angles.

Such a tank can be part of an onshore storage installation for storing LNG for example or installed in a floating structure for use in coastal or deep water, in particular a methane tanker ship, a floating storage and regasification unit (FSRU), a floating production storage and offloading (FPSO) unit, etc. Such a tanker can also serve as a fuel tank in any type of ship.

In a method of manufacturing a tank as described above for the second end of the anchor rod to cooperate with the anchor strip in such a manner as to transmit a traction force between the anchor strip and the support, said compressible clamping washer is compressed by means of a dedicated tool including:
a frame with two arms oriented toward one another in such a manner as to form an angle identical to that between the first and second tank walls and connected by a central part of the frame, the central part including a central orifice allowing the anchor rod to pass through it, each of the arms of the frame being pressed and blocked against one of the walls of the additional anchor strip in such a manner as to block the frame on the additional anchor strip,
a piston cylinder supported by the central part of the frame and including a central opening allowing the anchor rod to pass through it,
a bearing part having a shape adapted to compress said at least one compressible clamping washer while allowing the tightening of the nut by carrying out the following steps:
the frame of the dedicated tool is fixed to the additional anchor strip,
the actuator is actuated to bear on the bearing part, which compresses said at least one compressible clamping washer,
the nut is tightened through an access opening of the bearing part.

The dedicated tool is then removed by detaching it from the additional anchor strip.

In one embodiment a ship for transporting a cold liquid product includes a double hull and a sealed and an aforementioned thermally-insulating tank disposed in the double hull.

In one embodiment the invention also provides a transfer system for a cold liquid product, the system including the aforementioned ship, insulated pipes arranged in such a manner as to connect the sealed and thermally-insulating tank of the ship to a floating or onshore storage installation, and a pump for driving a flow of cold liquid product through the insulated pipes from or to the floating or onshore storage installation to or from the sealed and thermally-insulating tank of the ship.

In one embodiment the invention also provides a method of loading or off-loading a ship in which a cold liquid product is conveyed through insulated pipes from or to a floating or onshore storage installation to or from the sealed and thermally-insulating tank of the aforementioned ship.

### BRIEF DESCRIPTION OF THE FIGURES

The invention will be better understood and other aims, details, features and advantages thereof will become more clearly apparent in the course of the following description of particular embodiments of the invention given by way of non-limiting illustration only with reference to the appended drawings.

FIG. 1 is a partial perspective view of a first embodiment of the sealed and thermally-insulating tank showing a corner zone of the tank;

FIG. 2 is a partial view in section of the tank from FIG. 1;

FIG. 3 is a cutaway partial perspective view of the tank from FIG. 1;

FIG. 4 is a partial perspective view of the corner zone of the sealed and thermally-insulating tank from FIG. 1 during its manufacture showing the support and the corner anchor elements;

FIG. 5 is a partial view in section of a second embodiment of the tank;

FIG. 6 is a partial view in section of a third embodiment of the tank;

FIG. 7 is an exploded perspective view of a part of the corner anchor element from FIGS. 1 and 6;

FIG. 8, FIG. 9, FIG. 10, FIG. 11, FIG. 12 and FIG. 13 are partial perspective views of the corner zone of the first embodiment of the tank at various stages of manufacture;

FIG. 14 is a diagrammatic representation of a tool for compressing the clamping washers of the anchor rod;

FIG. 15 is a diagrammatic representation of a bearing part of the compression tool from FIG. 14;

FIG. 16 is a diagrammatic representation of the blocking end part of the corner anchor element of the tank from FIG. 1;

FIG. 17 is a diagrammatic cutaway representation of a methane tanker ship including the ship tank and a terminal for loading/offloading said ship.

### DESCRIPTION OF EMBODIMENTS

In the present description the terms “interior” and “exterior” are to be understood as describing a position relative to an interior respectively an exterior of the tank 100.

Identical or corresponding elements of the various embodiments are referenced by the same signs and are not described each time.

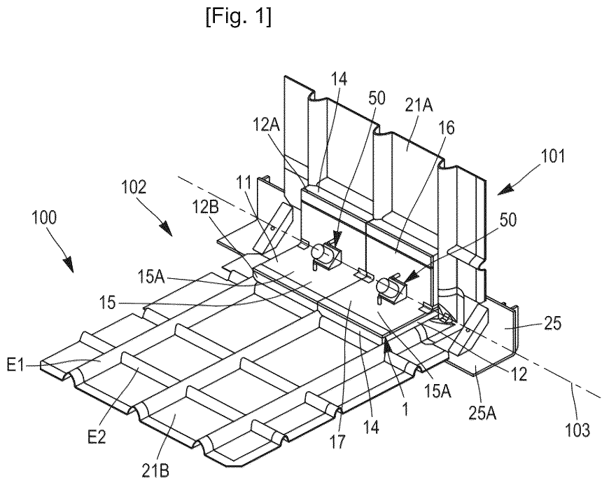

FIGS. 1 to 6 and 8 to 13 depict a portion of a sealed and thermally-insulating tank 100 including two walls 101, 102 with a non-zero angle between them.

As already mentioned above the invention concerns the production of a liquefied gas storage installation able to store a liquefied gas, in particular liquid hydrogen at a temperature of −253° C. at atmospheric pressure, liquefied natural gas (LNG) at a temperature of approximately −162° C. at atmospheric pressure, or other liquefied gases.

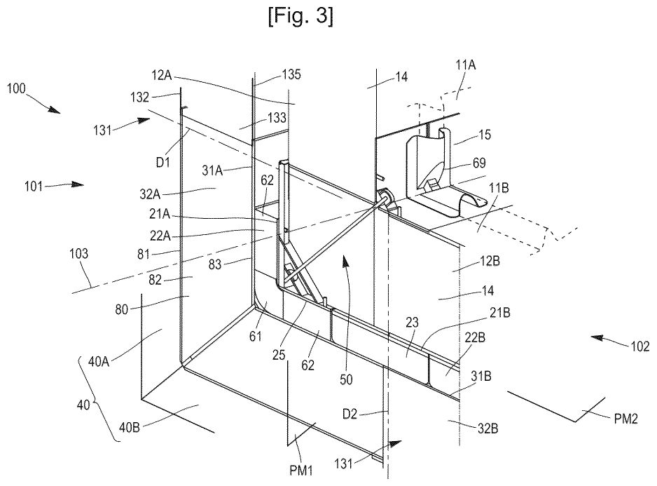

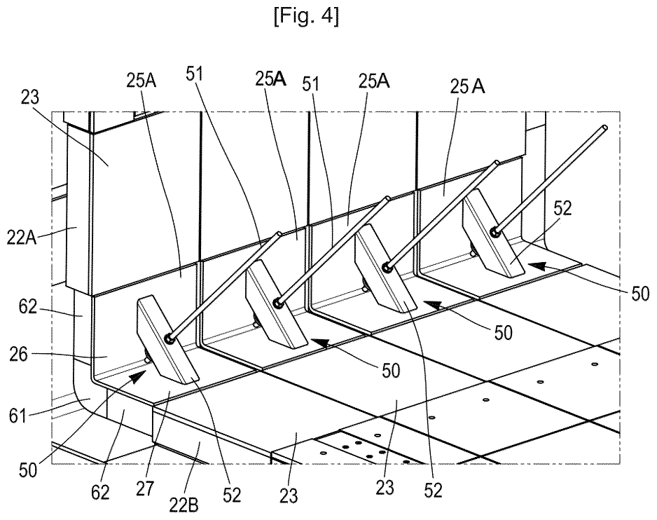

The installation 1 mainly includes a supporting structure 40 and a sealed and thermally-insulating tank 100 installed in the internal space of the supporting structure 40 (FIG. 3).

The supporting structure 40 is described first.

The supporting structure 40 is polyhedral.

It can include any type of supporting wall. It includes for example steel or concrete supporting walls. The supporting structure 40 includes a first supporting wall 40A and a second supporting wall 40B.

The installation including the supporting structure 40 and the tank 100 can be designed to be located on land. The second supporting wall 40B is then typically horizontal, that is to say situated in a plane perpendicular to the direction of the acceleration due to gravity, ignoring dimensional tolerances. It constitutes a bottom wall of the tank. The second supporting wall 40B can be situated at ground level or possibly below ground level. Here the supporting structure 40 is made of concrete.

Hereinafter there is more particularly considered the case of an installation situated on land where the second supporting wall 40B is horizontal. It is nevertheless to be made clear that the following description applies to any orientation of the second supporting wall 40B relative to the direction of the acceleration due to gravity.

In addition to the second supporting wall 40B the supporting structure 40 includes a first supporting wall 40A. It extends vertically for example when the second supporting wall 40B extends horizontally.

Alternatively the installation can be designed to be installed onboard a floating structure such as a ship. In this case the supporting structure is a portion of a double hull of the floating structure. The second supporting wall can be non-horizontal and even situated when the floating structure is at rest in a plane parallel to the direction of the acceleration due to gravity, ignoring dimensional tolerances.

The tank 100 preferably includes first walls 40A that together form a polygonal cylindrical surface where the polygon is formed by a polygonal contour of the second supporting wall 40B serving as a base. The first supporting wall 40A extends here in a vertical direction, that is to say in a direction perpendicular to the plane of the second supporting wall 40B, ignoring dimensional tolerances.

In a manner that is not represented in the drawings the supporting structure 40 includes at the end of a first supporting wall opposite the second supporting wall 40B a cover supporting wall closing the internal space delimited by the first and second supporting walls 40A, 40B. This cover supporting wall can support equipment usable to feed liquefied gas from or to this internal space.

Embodiments of a sealed and thermally-insulating tank 100 that can be installed in the internal space of the supporting structure 40 are described next with reference to FIGS. 1 to 13. The tank 100 includes a first wall 101 disposed on the first supporting wall 40A and a second wall 102 disposed on the second supporting wall 40B.

Each of the first and second walls 101, 102 extends in a median plane, the median planes of the walls 101, 102 forming an angle of 90° between them. Alternatively they can form an angle with a different, non-zero value, for example between 80° and 145°.

The first and second walls consist of layers of substantially uniform thickness that extend parallel to the median plane of the wall. The median plane of each wall is for example defined as the plane situated at the level of half the thickness of the wall.

A corner zone of the tank 100 situated in the vicinity of an edge 103 between the first and second walls 101, 102 is represented in FIGS. 1 to 6 and 8 to 13.

The edge 103 between the two walls 101, 102 is positioned here at the interior corner between the two walls (FIG. 1). It could be positioned at the exterior corner between the two walls. In other words each of the two walls 101, 102 includes an interior face facing the interior of the tank and an exterior face facing the exterior of the tank and here the edge 103 is defined as the intersection of the interior faces of the two walls. Alternatively it could be defined as the intersection of the exterior faces of the two walls.

The interior and exterior faces of the two walls are parallel to the median plane of each wall.

The edge can generally equally well designate a place of intersection of the median planes of the first and second walls 101, 102.

The figures represent an example of a GST® type wall for an onshore LNG tank converted into a liquid hydrogen tank.

The structure of each of the first and second walls 101, 102 is therefore that of a classic GST® type wall as described for example in the document FR2102974 to which an additional insulating and sealed layer is added.

The first wall 101 includes in a first direction of thickness D1 (FIG. 3) of the first tank wall perpendicular to the median plane of this first wall 101 and from the exterior to the interior of the tank:
a classic stack of two secondary and primary insulating and sealed layers with a first secondary thermally-insulating barrier 32A covered by a first secondary sealed membrane 31A that supports a first primary thermally-insulating barrier 22A with a first primary sealed membrane 21A, and
a first additional thermally-insulating barrier 12A disposed against the first primary sealed membrane 22A and supporting a first additional sealed membrane 11A.

The first additional thermally-insulating barrier 12A rests on the stack of two primary and secondary insulating and sealed layers anchored in the first supporting wall 40A of the supporting structure 40 (FIG. 3).

A second wall 102 of the two walls 101, 102 includes in a second direction of thickness D2 (FIG. 3) of the second tank wall perpendicular to the median plane of this second wall 102 and from the exterior to the interior of the tank:
a classic stack of two secondary and primary insulating and sealed layers with a second secondary thermally-insulating barrier 32B covered by a second secondary sealed membrane 31B that supports a second primary thermally-insulating barrier 22B with a second primary sealed membrane 21B, and
a second additional thermally-insulating barrier 12B disposed against the second primary sealed membrane 22B and supporting a second additional sealed membrane 11B.

The second additional thermally-insulating barrier 12B rests on the stack comprising the two primary and secondary insulating and sealed layers anchored in the second support wall 40B of the supporting structure 40 (FIG. 3).

The various embodiments represented in the figures differ only in the arrangement of the insulating blocks forming part of the first and second additional thermally-insulating barriers.

There is described next with reference to FIG. 3 the structure of the secondary and primary walls of the first and second walls 101, 102 in accordance with the first, second and third embodiments. This can mean for example a vertical wall and a bottom wall of the tank.

As represented in this figure, near the junction between the first and second walls 101, 102 the first and second secondary thermally-insulating barriers 32A, 32B include a corner structure including a corner block 80. This corner block 80 includes two pairs of plates 81, 83 made of plywood for example between which are glued two thermally-insulating foam blocks 82.

The corner block 80 is extended along each of the first and second walls 101, 102 by insulating blocks 131. The thickness of the corner block 80 is preferably equal to the thickness of the foam block 133 of the insulating blocks 131.

The insulating blocks 131 can include a bottom plate 132, a block of foam 133 disposed on the bottom plate 132, and a cover plate 135 disposed on the block of foam 133. The bottom plate 132 and the cover plate 135 can be made of plywood. The block of foam 133 can be made of polyurethane foam, possibly fibre-reinforced polyurethane foam. In the embodiment described here these blocks correspond to the GST® technology marketed by the applicant and described in the document FR2102974 for example. See also the document U.S. Pat. No. 6,035,795 for a description of some of the blocks.

Parallel beads of mastic (not represented) and shims (not represented) are disposed between the corner block 80 or the insulating blocks 131 and the first and second supporting walls 40A, 40B.

The insulating blocks 131 and the corner block 80 represented in FIG. 3 together form a plane surface onto which are glued the first and second secondary sealed membranes 31A, 31B.

The first and second secondary sealed membranes 32A, 32B are formed for example by a strip of flexible material that covers the insulating blocks 131 and the corner block 80. This flexible material can be a three-layer composite material comprising glass fibres, aluminium and glass fibres.

Alternatively the first and second secondary sealed membranes 32A, 32B can equally well comprise metal plates with corrugations similar to those described later for the primary sealed membrane.

The first and second primary thermally-insulating barriers 22A, 22B are anchored onto the insulating blocks 131 and the corner block 80 of the first and second secondary thermally-insulating barriers 32A, 32B.

In practice each of the first and second primary thermally-insulating barriers 22A, 22B comprises a plurality of primary insulating blocks 23.

Between the corner block 80 of the first and second secondary thermally-insulating barriers 32A, 32B and the first and second primary sealed membranes 21A, 21B each of the first and second primary thermally-insulating barriers 22A, 22B includes blocks of wood 62 that carry primary angle irons 25A, each primary angle iron 25A being fixed, for example screwed, to the blocks 62. Between the wood blocks 62 is glued an insulating plate 61 forming the corner between the first and second primary thermally-insulating barriers 22A, 22B.

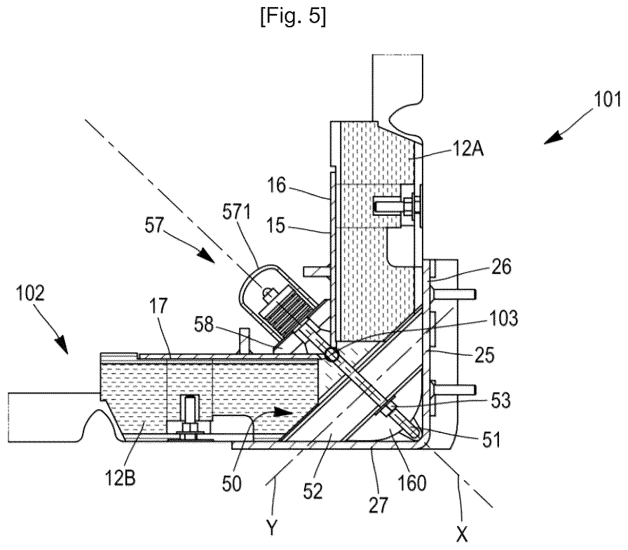

The insulating blocks 23 are represented in FIGS. 3 and 5 and together form a plane surface onto which are anchored the first and second primary sealed membranes 21A, 21B.

Each of the first and second primary sealed membranes 21A, 21B consists of a plurality of sealed membrane elements in the form of metal plates juxtaposed to one another with an overlap. These metal plates are preferably of rectangular shape. The metal plates are welded together to seal the sealed membrane. The metal plates are for example made of stainless steel 1.2 mm thick.

Alternatively this can be any type of sealed membrane made for example of a manganese alloy or Invar®: that is to say an alloy of iron and nickel the coefficient of expansion of which is typically between 1.2×10⁻⁶ K⁻¹ and 2×10⁻⁶ K⁻¹.

The liquefied gas to be stored in the tank 100 can in particular be liquid hydrogen or a liquefied natural gas (LNG), that is to say a gas mixture comprising mostly methane together with one or more other hydrocarbons. The liquefied gas can equally well be ethane or a liquefied petroleum gas (LPG), that is to say a mixture of hydrocarbons produced by refining petroleum essentially comprising propane and butane.

In order to enable deformation of the sealed membrane in response to the various loads to which the tank is subjected, in particular in response to thermal contraction resulting from loading liquefied gas into the tank, the metal plates include a plurality of corrugations E1, E2 oriented toward the interior of the tank (FIG. 1). Each metal plate more particularly includes two series of perpendicular corrugations forming a regular rectangular pattern. The corrugations preferably extend parallel to the edges of the rectangular metal plates. This is represented in FIG. 1 for the first and second primary sealed membranes 21A, 21B.

The first and second primary sealed membranes 21A, 21B are connected to one another by a metal anchor strip described later at the same time as describing the metal anchor strip connecting the first and second additional sealed membranes 11A, 11B.

The structure of the additional layer in the first, second and third embodiments is described next with reference to FIGS. 1, 2, 3, 4 and 6.

The first and second additional thermally-insulating barriers 12A, 12B include a row of edge insulating blocks 14 disposed along the direction of the edge 103 (FIGS. 1 and 5). The edge insulating blocks 14 are anchored onto the underlying wall by any appropriate means, for example by means of anchor members described in more detail later.

Each edge insulating block 14 comprises for example two external plates between which is a thickness of an insulating material, for example an insulating foam. The external plates are made of plywood for example.

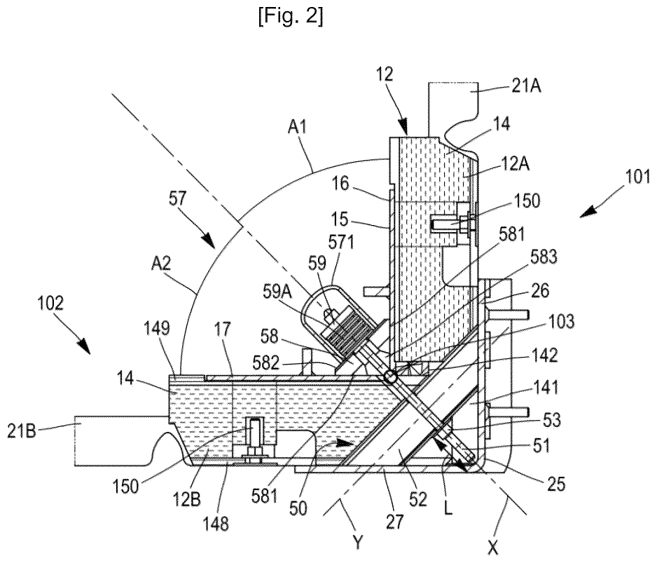

Three embodiments of the tank that differ in the arrangement of the edge insulating blocks are represented in FIGS. 2, 5 and 6.

In the first embodiment from FIGS. 1 to 4 and 7 to 12 the edge insulating blocks 14 of the second wall 102 extend beyond the edge 103 until they face the edge of the edge insulating blocks of the first wall 101. First filler packings 141 are disposed between the edge of the edge insulating blocks 14 of the second wall and the supporting structure 40 and second filler packings 142 are disposed between the edge of the edge insulating blocks of the first wall 101 and the edge insulating blocks of the second wall. The filler packings 141 and 142 serve to prevent natural convection and are made for example of glass wool or polymer foam.

In the FIG. 3 second embodiment the edge insulating blocks of the first and second walls do not extend beyond the edge 103. A filler element 160 is provided along the edge 103 between the edge insulating blocks of the first and second walls to limit convection.

In the third embodiment the edge insulating blocks of the first and second walls are formed as follows: corner edge insulating blocks 14 are used consisting of two parts with an angle between them equal to that between the tank walls 101, 102.

In each embodiment the edge insulating blocks 14 of each of the first and second walls 101, 102 are extended by additional insulating blocks (not represented in the figures) that are similar to the insulating blocks of the secondary and primary thermally-insulating barriers. Note that the thicknesses of the insulating blocks used to form the various secondary, primary and additional layers can be different.

To provide excellent thermal insulation for storing liquid hydrogen the thickness of the additional insulating blocks used for the thermally-insulating barrier is greater than the thickness of the insulating blocks used for the first and second secondary and primary thermally-insulating barriers.

Each of the first and second additional membranes 11A, 11B can include a metal, for example stainless steel, corrugated membrane similar to that described hereinabove and represented in FIG. 1 for the primary sealed membrane. This type of sealed membrane is described in particular in the publication WO-A-2010040922 or FR-A-2861060.

In order to connect the first and second additional sealed membranes 11A, 11B and the first and second primary sealed membranes 21A, 21B of the first and second walls 101, 102 the tank includes two anchor strips referred to hereinafter as the additional anchor strip 15 and the primary anchor strip 25.

Each of the additional anchor strip 15 and the primary anchor strip 25 includes a row of metal angle irons 15A, 25A arranged in line with the edge 103. These angle irons 15A, 25A are aligned in the direction of the edge 103. Overall these angle irons 15A, 25A are connected two by two in sealed manner along the direction of the edge 103 to seal the additional sealed membrane in line with the edge 103. Overall the first and second additional sealed membranes 11A, 11B form with the anchor strip 15 a portion of the additional sealed membrane of the tank that is intended to come into contact with the liquefied gas contained in the tank 100.

As depicted in FIGS. 1 to 5 each angle iron 15A, 25A takes the form of a bent rectangular plate with an L-shape profile and includes two flanges 16, 17, 26, 27.

The two flanges 16, 17, 26, 27 of each angle iron 15A, 25A form between them an angle equal to the angle between the two tank 101, 102 walls 101, 102. The intersection between the two flanges 16, 17 of the angle irons 15A of the additional angle strip 15 constitutes the edge 103 between the tank walls 101, 102. The intersection between the two flanges 26, 27 of the angle irons 25A of the primary anchor strip 25 extends in a direction parallel to the direction of the edge 103 between the two tank walls 101, 102.

Each of the two flanges 16, 17 of one of said angle irons 15A of the additional anchor strip 15 extends parallel to one of the two walls 101, 102. A first flange 16 of these two flanges 16, 17 rests on one or more edge insulating blocks 14 of the first additional thermally-insulating barrier 11A of the first tank wall 101. A second flange 17 of these two flanges 16, 17 rests on one or more edge insulating blocks 14 of the second additional thermally-insulating barrier 11B of the second tank wall 102.

An edge of the first additional sealed membrane 11A of the first tank wall 101 is anchored in sealed manner, for example by means of an overlapping weld, on the first flanges 16 of the row of angle irons 15A forming the additional anchor strip 15. Similarly, an edge of the second additional sealed membrane 11B of the second tank wall 102 is anchored to the second flanges 17 of the row of angle irons 15A forming the additional anchor strip 15.

The additional anchor strip 15 is made of metal and carries a plurality of corner junction parts 69. Each corner junction part 69 includes two sleeves, an end of a corrugation E1 of each of the first and second additional sealed membranes 11A, 11B being received in these sleeves. The corner junction part 69 therefore forms a continuous connection between the facing corrugations E1 of the first and second additional sealed membranes.

Each of the two flanges 26, 27 of one of said angle irons 25A of the primary anchor strip 25 extends parallel to one of the two walls 101, 102 of the tank 100. A first flange 26 of these two flanges 26, 27 rests on one or more edge insulating blocks 24 of the first primary thermally-insulating barrier 22A of the first supporting wall 40A. A second flange 27 of these two flanges 26, 27 rests on one or more edge insulating blocks 24 of the second primary thermally-insulating barrier 22B.

An edge of the first primary sealed membrane 21A of the first wall 101 is anchored in sealed manner, for example by means of an overlapping weld, on the first flanges 27 of the angle irons 25A of the primary anchor strip 25. Similarly, an edge of the second primary sealed membrane 21B of the second wall 102 is anchored on the second flanges 27 of the angle irons 25A of the primary anchor strip 25.

Each angle iron 15A of the additional anchor strip 15 is anchored on the first and second primary thermally-insulating barriers 22A, 22B by means of the corner anchor elements 50 represented in the figures.

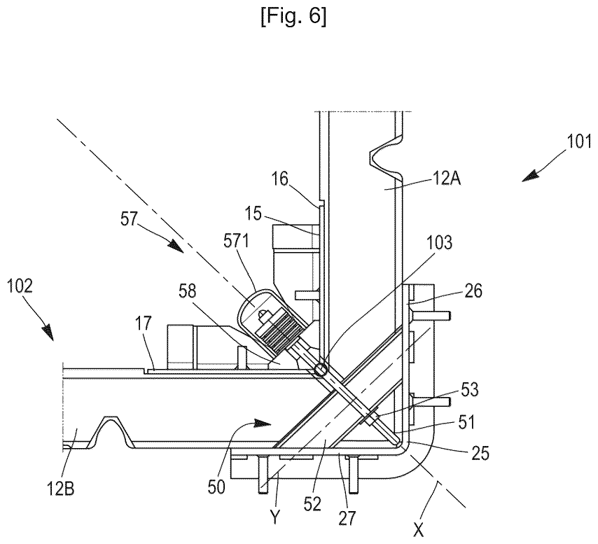

Each of these corner anchor elements 50 includes, as represented in FIG. 6:
an anchor rod 51,
an anchor bar 52, and
a blocking end part 57.

The anchor rod 51 extends in an extension direction X (FIGS. 1 and 6) that crosses said edge 103 between the first and second walls 101, 102.

Here, in the case of a dihedral angle between two walls the anchor rod 51 extends perpendicularly to the edge 103.

The anchor rod 51 extends in an extension plane passing through said edge 103 inclined at a non-zero angle A1, A2 relative to each of said first and second tank walls 101, 102 (FIG. 2).

Here the insulating blocks forming the first and second additional thermally-insulating barriers 12A, 12B are the same thickness along the two tank walls 101, 102. The anchor rod 51 then extends in a direction that bisects the tank corner formed between the two tank walls 101, 102. In other words the extension plane of the anchor rod 51 divides the angle between the walls 101, 102 of the tank into two equal angles A1, A2.

If the insulating blocks forming the additional thermally-insulating barrier 12 along the two walls 101, 102 of the tank did not have identical thicknesses the anchor rod 51 would then extend in a direction that does not bisect the tank corner formed between the two tank walls 101, 102.

The anchor rod 51 generally extends in a direction that crosses the intersection of the two flanges 26, 27 of the angle irons 25A of the primary anchor strip 25 and the intersection of the two flanges 16, 17 of the angle irons 15A of the additional anchor strip 15. It extends more particularly in an extension plane passing through the intersection of the two flanges 26, 27 of the angle irons 25A of the primary anchor strip 25 and the intersection of the two flanges 16, 17 of the angle irons 15A of the additional anchor strip 15.

The anchor strip 52 is anchored in the support. It has an elongate shape in a longitudinal direction Y (FIG. 6). This longitudinal direction Y of the anchor strip 52 is perpendicular to the extension direction X of the anchor rod 51 (FIG. 2).

To be more precise here the anchor bar 52 is anchored on the primary anchor strip 25 that forms the sealed connection between the primary sealed membrane elements 21 of the supporting walls of the supporting structure.

The anchor bar 52 is for example welded onto the anchor strip 25 connecting the first and second thermally-insulating barriers.

To be more precise the longitudinal direction Y of the anchor bar 52 extends in such a manner as to form a non-zero angle with each of the walls 101, 102 of the tank.

Here it extends between the flanges 26, 27 of one of the angle irons 25A of the primary anchor strip 25. Here it forms an angle of 45° with each of the two flanges 26, 27.

The anchor bar 52 has a central part of polygonal or circular section. Here the section of the central part of the anchor bar 52 is rectangular. A polygonal section provides good stiffness of the anchor bar and easy welding of said bar onto the supporting structure 40. The anchor bar 52 therefore provides effective take-up of forces.

The longitudinal ends of the anchor bar 52 are bevelled in a manner suited to the walls 101, 102. The longitudinal ends of the anchor bar 52 in practice extend in two planes forming between them an angle equal to the angle between the walls 101, 102 of the tank.

Here the walls supporting the anchor bar are oriented at 90° to one another. The ends of the anchor bar are each bevelled at 45° relative to the longitudinal direction X of the bar. It is moreover economically advantageous to use anchor bars having ends oriented at 45° to the longitudinal direction X of the bar because the production of these anchor bars by cutting a profiled member produces no waste.

The anchor bar 52 is formed of a hollow external wall delimiting an internal housing 56. The internal housing 56 of the anchor bar 52 preferably contains a thermally-insulating packing material, for example an insulating foam or glass wool.

Alternatively the anchor bar 52 can be solid and in one piece.

The central part of the anchor bar includes an orifice 56A through it that receives a first end 51A of the anchor rod 51. This through-orifice 56A can pass through the hollow external wall and the packing material.

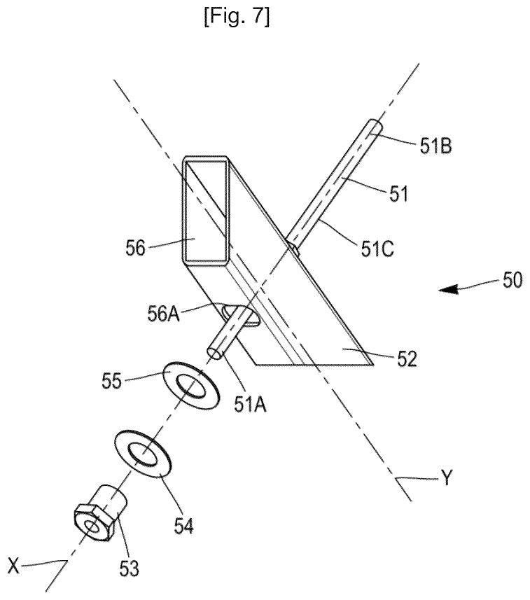

As can be seen in FIG. 7 the through-orifice 56A preferably has dimensions slightly greater than those of the anchor rod 51. This makes it possible to provide a clearance useful for mounting the corner anchor element.

The first end 51A of the anchor rod 51 extends beyond the anchor bar 52 in the direction toward the exterior of the tank 100 (FIG. 7). It extends beyond the anchor bar 52 by a length L adapted to prevent contact with the supporting structure 40 (FIG. 2). This length is for example less than or equal to 3 centimetres.

The anchor rod 51 is at least partly threaded.

Thus the anchor rod 51 is fixed against the anchor bar 52 by a nut 53 screwed onto the first end 51A of the anchor rod 51 (FIGS. 2, 3 and 4). This nut 53 is preferably spot-welded to the anchor bar 52 in order to prevent unscrewing and loosening of the nut 53. Here the nut 53 is welded to the exterior face of the anchor bar 52 facing the supporting structure 40.

It is possible to place between the nut 53 and the exterior face of the anchor bar 52 one or more elastic clamping washers similar to spring washers 59A described later.

A knuckle nut is preferably used in order to load the anchor rod 51 in tension.

A central part 51C of the anchor rod 51 passes through the anchor bar 52, the additional thermally-insulating barrier 12 and the additional anchor strip 15.

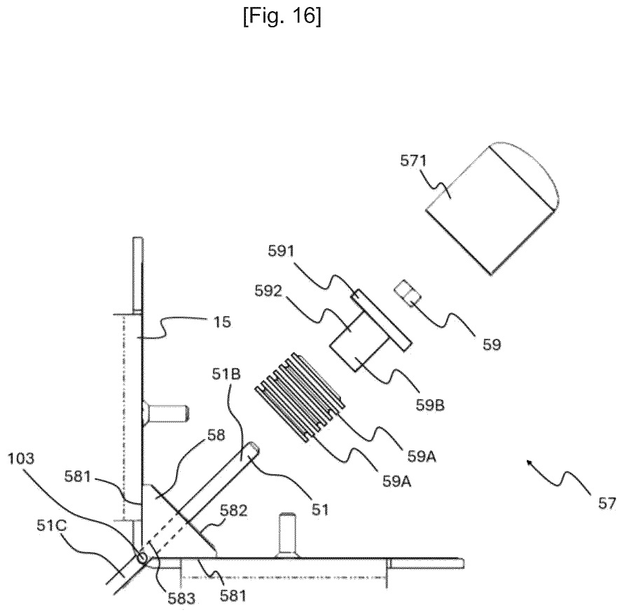

A second end 51B of the anchor rod 51 projects from the additional anchor strip 15 and cooperates with the blocking end part 57 (FIG. 16) to load the anchor rod 51 in tension.

The blocking end part 57 includes a corner abutment part 58 (FIGS. 2, 5, 6 and 16) that is corner-shaped. This corner abutment part 58 has two lateral faces 581 adapted to be pressed against the flanges 16, 17 of the additional anchor strip 15 and a main face 582 through which the second end 51B of the anchor rod 51 projects (FIGS. 2, 16). It includes a central opening 583 through it that extends diagonally in a direction inclined relative to the two lateral faces 581 of the corner abutment part 58 and opens onto the main face 582 of this corner abutment part 58. The anchor rod 51 passes through this through-opening 583 (FIGS. 2, 16).

The second end 51B of the anchor rod 51 receives a blocking nut 59 that blocks the corner abutment part 58 axially, in the direction of the anchor rod 51, against the additional anchor strip 15 of the additional sealed membrane and a sealed protective cover 571 that covers said second end 51B of the anchor rod 51 entirely.

The sealed protective cover 571 is bell-shaped with the free edge welded onto the main face 582 of the corner abutment part 58 all around the second end 51B of the anchor rod 51 in order to make the seal (FIGS. 2 to 4).

In the example represented in the appended figures spring washers 59A are disposed between the nut 59 and the corner abutment part 58 (FIGS. 2, 5, 6 and 16). These spring washers are optional.

The spring washers 59A are not flat washers. They include for example a plane part and at least one curved or bent part projecting on one side of the plane part. The spring washers 59A have an elasticity in the clamping direction. They make it possible to hold the corner abutment part 58 pressed against the additional anchor strip 15 despite thermal contraction or creep of the insulating blocks.

The number of spring washers 59A used is determined as a function of the travel needed and/or the required compression. As a function of what is required the spring washers can be either parallel, that is to say with their curved or bent part disposed on the same side, or opposed, that is to say with their curved or bent part disposed alternately on one side and the other of the plane part, or a mixture of the foregoing two possibilities. The total travel of the spring washers, in other words the variation of thickness of the stack of spring washers when compressed, and the force necessary to compress them are determined as a function of the composition of the insulating blocks: stiffness, thickness, coefficient of thermal contraction, creep behaviour, etc.

There are between 2 and 10 clamping spring washers 59A for example. There are preferably between 4 and 7 compressible spring washers 59A disposed between the nut and the spring washers 59A. In the FIG. 16 example 7 oppositely oriented “Belleville” type washers are stacked. Alternatively they can be stacked in parallel. The number of spring washers generally depends on the thickness of the insulating blocks of the underlying barrier.

Each spring washer 59A includes a central opening enabling it to be threaded onto the anchor rod 51. The first spring washer 59A threaded onto the anchor rod 51 is disposed against the main face 582 of the corner abutment part 58.

The blocking end part 57 further includes a spacer 59B including a circular base 591 from which extends a sleeve 592. The sleeve 592 extends around a central opening in the circular base 591 of the spacer 59B.

The sleeve 592 of the spacer 59B is threaded onto the anchor rod 51 through the central openings of the spring washers 59A. The circular base 591 of the spacer 59B comes up against the last spring washer 59A in the stack of spring washers threaded onto the anchor rod 51. The central opening in the circular base 591 is smaller than the central opening in the spring washers so that the nut 59 can be screwed against the circular base 591 of the spacer 59B.

The through-opening 583 of the corner abutment part 58 has dimensions larger than those of the anchor rod 51. This through-opening 583 also allows the passage of the sleeve 592 of the spacer 59B, which is therefore able to slide along the anchor rod 51.

The nut 59 is then screwed onto the anchor rod 51 and tightened against the circular base 591 of the spacer 59B.

The presence of the spacer 59B allows a smaller number of spring washers to be used by facilitating clamping thereof.

Alternatively using a non-compressible washer instead of the spacer 59B can be envisaged.

Thus the stack of spring washers 59A is progressively compressed by tightening the nut 59 onto the anchor rod 51 and the stack of spring washers 59A is blocked between the nut 59 and the corner abutment part 58. Each clamping washer is compressed to approximately 80% of its maximum compression. The stack measures for example approximately 3.5 cm before compression and is compressed by 7 millimetres. This compression enables take-up of stresses generated by thermal contraction of the additional sealed membrane and ensures that the corner abutment parts 58 remain in contact with the additional anchor strip 15.

There are a number of methods for carrying out this compression.

In a first method the spring washers 59A are compressed manually by tightening the nut 59 against the circular base 591 of the spacer 59B and the spring washers 59A. To this end a torque of 20 N/m is applied to the nut. The nut 59 is then spot-welded to prevent it loosening. This method has the drawback that there is a risk of torsion being applied to the anchor rod 51 and damaging it. Two persons are then necessary to carry out the clamping, one holding the anchor rod 51 while the other tightens the nut 59.

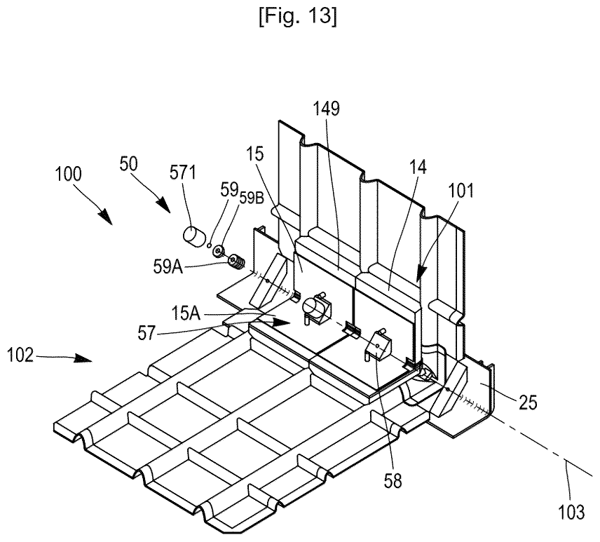

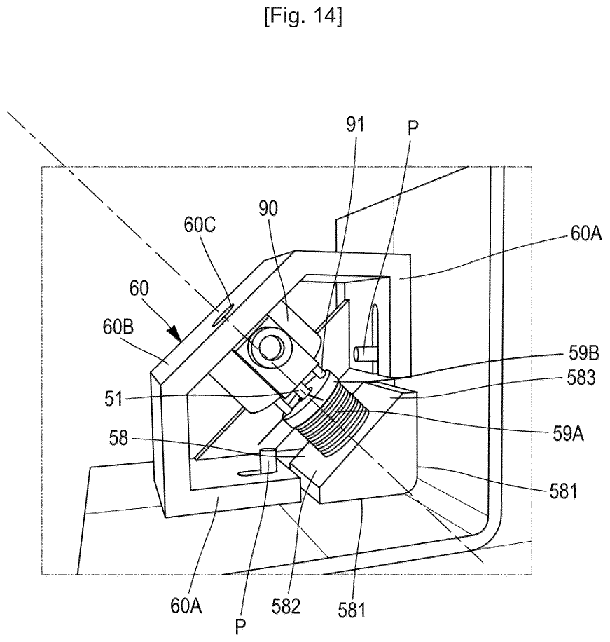

In a second method the spring washers 59A are compressed using a dedicated tool represented in use in FIG. 14. The nut 59 is not represented in FIG. 14.

The dedicated tool includes a frame 60 with two arms 60A oriented toward one another in such a manner as to form an angle identical to that between the first and second tank walls 101, 102 and connected by a central part 60B of the frame 60. The central part 60B includes a central orifice 60C allowing the anchor rod 51 to pass through it.

The free end of one of the arms 60A includes a slot opening onto the free edge of said arms 60A while the other arm includes an oblong opening in the vicinity of its free edge.

The slot and the oblong opening each allow the passage of a mounting peg P provided in the additional anchor strip 15 of the additional sealed membrane. The arms 60A of the frame 60 are therefore pressed against the walls of the additional anchor strip 15. Each mounting peg P is threaded and a nut is screwed onto each peg P in such a manner as to block the frame 60 on the additional anchor strip 15 of the additional sealed membrane. The dedicated tool further includes a piston cylinder 90 supported by the central part 60B of the frame 60. This actuator 90 includes a central opening aligned with the central orifice 60C of the central part 60B of the frame 60 to allow the anchor rod 51 to pass through it.

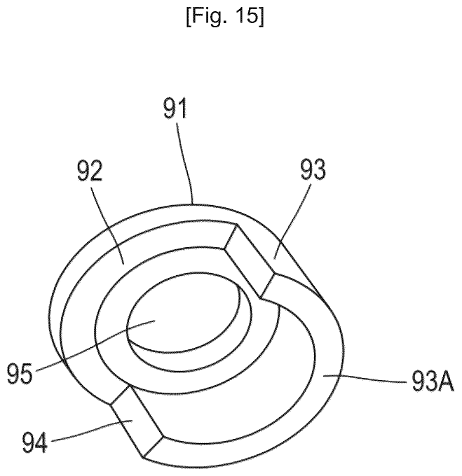

The dedicated tool further includes a bearing part 91 more particularly represented in FIG. 15. This bearing part 91 has a shape adapted to compress the spring washers 59A while allowing tightening of the nut 59.

To this end the bearing part 91 includes an annular bearing plate 92 including a central opening 95 which allows the anchor rod 51 to pass through it. A bearing face of the bearing plate 92 is oriented toward the actuator 90. The bearing part 91 further includes a drop wall 93 that extends along a part of the circumference of the bearing plate 92. This drop wall 93 has a part-cylindrical shape. Here the drop wall extends over a half-circumference of the bearing plate 92.

The free edge 93A of the drop wall 93 is pressed against the circular base 591 of the spacer 59B around the nut 59 screwed beforehand onto the anchor rod 51.

It transmits to the stack comprising the spacer 59B and the spring washers 59A the pressure exerted by the hydraulic actuator 90 on the bearing plate 92 of the bearing part 91.

As the drop wall 93 extends along only a part of the circumference of the bearing plate 91 the nut 59 rests accessible to a tightening tool through the bearing part 91. An access opening 94 is defined between the bearing plate 92 and the drop wall 93.

A single operator can therefore fix the frame 60 fitted with the hydraulic actuator 90 onto the additional sealed membrane by tightening the nuts onto the mounting pegs P and then actuating the hydraulic actuator 90 so as to compress the spring washers 59A and finally tighten the nut 59 manually after this compression. The nut 59 when tightened is spot-welded in order to prevent it loosening. The frame 60 and the hydraulic actuator 90 are then removed.

An RCH120 700 bar hollow piston cylinder having a travel of 8 mm can be used for example.

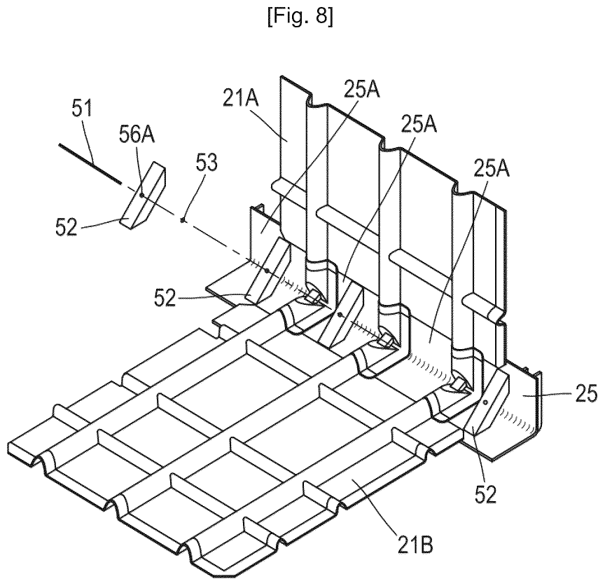

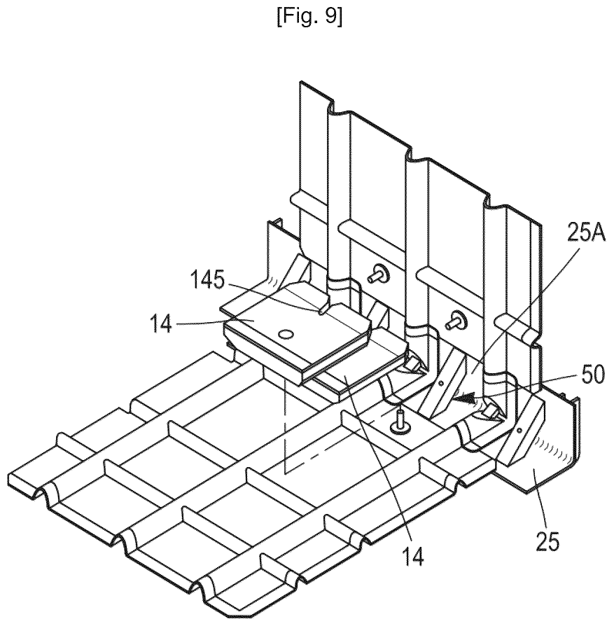

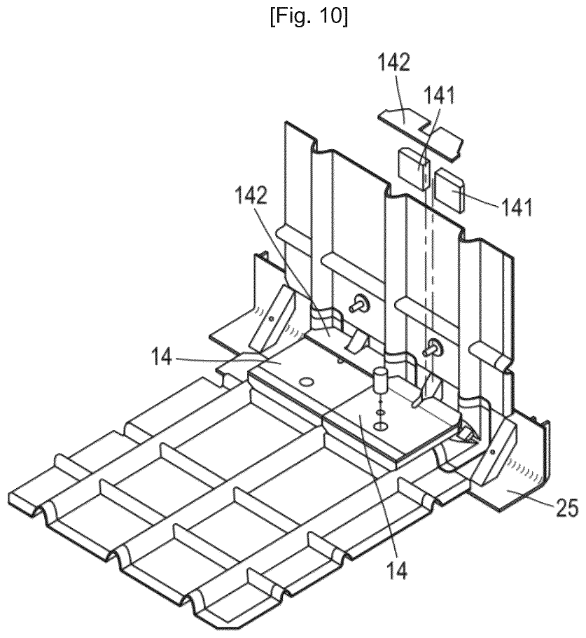

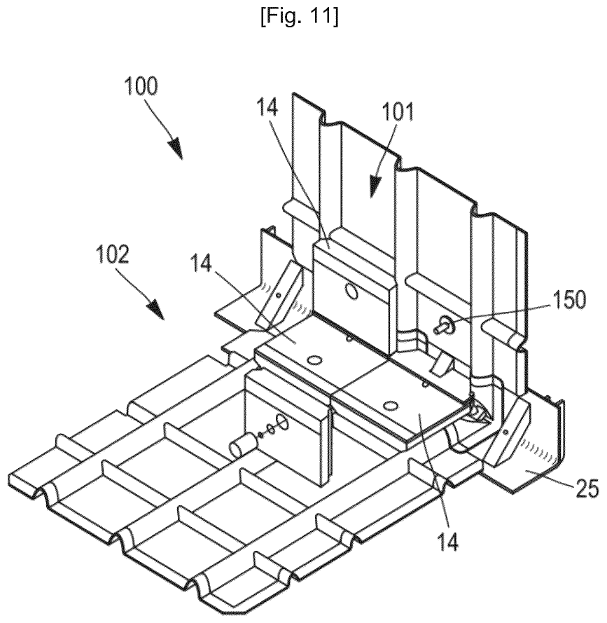

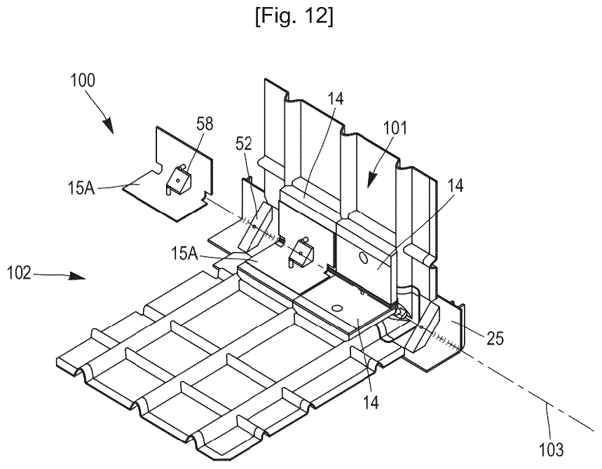

In the corner zone the assembly of the sealed and thermally-insulating tank 100 can include the following steps:
the anchor bars 52 are welded onto the angle irons 25A of the primary anchor strip 25: an anchor bar 52 is for example welded onto each angle iron 25 of the primary anchor strip 25 (FIG. 7),
the anchor rod 51 is passed through the through-orifice 56A in the anchor bar 52 and fixed to the anchor bar 52 by screwing the nut 53 onto the first end 51A of the anchor rod 51 and the nut 53 is welded onto the anchor bar 52 (FIG. 7),
the edge insulating blocks 14 of the second additional thermally-insulating barrier 12B are installed against the angle irons 25A of the primary anchor strip 25 (FIG. 8). To this end the edge insulating blocks 14 include a notch 145 adapted to accommodate the anchor bar 52 and to allow the anchor rod 51 to pass through it (FIG. 8).

The edge insulating blocks 14 are fixed by means of anchor members (FIG. 10) including for example a peg 150 projecting from the first and second primary sealed membranes 22A, 22B. This peg 150 passes through an opening in the exterior plate 148 of the edge insulating block 14, the exterior plate 148 of the edge insulating block 14 being disposed against the primary anchor strip 25. A nut and a washer clamp the exterior plate 148 of the edge insulating block 14 against the primary anchor strip 25 (FIGS. 2-4 and 10).

First shims 141 are installed between each edge insulating block 14 of the second wall 102 and the first flange 26 of the corresponding angle iron 25A of the primary anchor strip 25. Second shims 142 are installed on the edge insulating blocks 14 of the second wall 102 and the shims 141 in order to be disposed between these edge insulating blocks 14 of the second wall 102 and the edge insulating block 14 of the adjoining first wall 101 (FIG. 10).

The edge insulating blocks 14 of the first wall 101 are disposed against the first flanges 26 of the primary anchor strip 25 and fixed by means of anchor members similar to those described for the second wall 102 (FIGS. 2 and 11).

The angle irons 15A forming the additional anchor strip 15 of the primary sealed membrane 11 are disposed on the edge insulating blocks 14 forming the first and second additional thermally-insulating barriers 12A, 12B: the first flange 16 of each angle iron 15 is pressed against the interior plate 149 (FIG. 13) of the corresponding edge insulating block 14 of the first wall 101 and the second flange 17 of each angle iron 15 is pressed against the interior plate 149 of the corresponding edge insulating block 14 of the second wall 102.

Each angle iron 15A of the additional anchor strip 15 has dimensions corresponding to those of the edge insulating blocks 14 of the first and second thermally-insulating barriers 12A, 12B. There is one anchor element 50 per angle iron 15A centred relative to the latter. To this end each angle iron 15A includes at the centre of its edge a central orifice for the anchor rod 51 to pass through. The corner abutment part 58 of each anchor element 50 is disposed at the level of the central orifice.

The corner abutment part 58 is an attached part as described hereinabove that is preferably pre-assembled onto the angle iron 15A before installation.

Finally the blocking end part is installed: here a set of spring washer 59A and a spacer 59B are threaded around the second end 51B of the anchor rod 51 and clamped by a blocking nut 59, for example by one of the methods described hereinabove. The cover 571 covers the second end of the anchor rod 51 with the spring washers 59A and the nut 59. It is welded to the main face 582 of the corner abutment part 58.

The corner anchor element 50 is described here in its use in a dihedral corner zone of the tank. It can equally well be used in a trihedral type corner zone. The corner anchor element is then disposed at the intersection of the edges formed between the three tank walls.

The technique described hereinabove for producing a tank wall can be used in various types of tank.

It has been described here in the case of assembling an additional layer of the tank surmounting an existing wall already including two secondary and primary sealed insulating layers but can equally well be used to constitute a primary layer of an LNG tank in an onshore installation including a single insulating and sealed layer or in a floating structure such as a methane tanker or other ship. It can also be used to assemble a single insulating and sealed layer onto a supporting structure of an onshore tank or a tank in a floating structure.

Furthermore all the walls of the tank have a similar structure, the description of a tank wall hereinafter applying by analogy to the other tank walls. Accordingly the description hereinafter of FIGS. 1 to 16 is given in the context of a tank angle of 90° but this description is equally applicable by analogy to tank corners having other configurations, such as other walls forming angles of 135°.

Finally the description here describes adding an insulating and sealed layer to a GST® type wall such as described in the document FR2102974. However the tank described could equally include Mark III type walls as described in the document FR 2781557. The corner anchor element could therefore be used to add an additional thermally-insulating barrier and an additional sealed membrane to other types of wall.

Thanks to the corner anchor element it is possible to anchor an additional sealed and thermally-insulating layer rapidly and effectively to a supporting wall or to a pre-existing tank wall, in particular a primary sealed membrane of a tank for storing LNG.

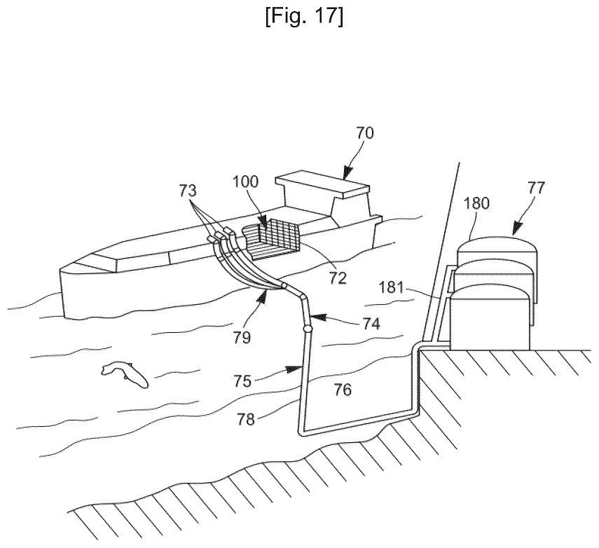

Referring to FIG. 17, a cutaway view of a methane tanker ship 70 shows a sealed and insulated tank 100 of prismatic general shape mounted in the double hull 72 of the ship 70. The wall of the tank 100 includes a primary sealed membrane intended to be in contact with the LNG contained in the tank, a secondary sealed membrane arranged between the primary sealed membrane and the double hull 72 of the ship 70, and two thermally-insulating barriers respectively arranged between the primary sealed membrane and the secondary sealed membrane and between the secondary sealed membrane and the double hull 72.

In a manner known in itself loading/offloading pipes 73 disposed on the top deck of the ship may be connected by means of appropriate connectors to a maritime or harbour terminal to transfer a cargo of LNG from or to the tank 100.

FIG. 17 shows an example of a maritime terminal including a loading and offloading station 75, an underwater pipe 76 and an onshore installation 77. The loading and offloading station 75 is a fixed off-shore installation including a mobile arm 74 and a tower 78 that supports the mobile arm 74. The mobile arm 74 carries a bundle of insulated flexible tubes 79 that can be connected to the loading/offloading pipes 73. The orientable mobile arm 74 adapts to all methane tanker loading gauges. A connecting pipe that is not shown extends inside the tower 78. The loading and offloading station 75 enables loading and offloading of the methane tanker 70 from or to the onshore installation 77. The latter includes liquefied gas storage tanks 180 and connecting pipes 181 connected via the underwater pipe 76 to the loading or offloading station 75. The underwater pipe 76 enables transfer of the liquefied gas between the loading or offloading station 75 and the onshore installation 77 over a great distance, for example 5 km, which enables the methane tanker ship 70 to remain at a great distance from the coast during loading and offloading operations.

Pumps onboard the ship 70 and/or pumps equipping the onshore installation 77 and/or pumps equipping the loading and offloading station 75 are used to generate the pressure necessary to transfer the liquefied gas.

Although the invention has been described in connection with particular embodiments it is obvious that it is in no way limited to them and that it encompasses all technical equivalents and combinations of the means described if they fall within the scope of the invention.

The use of the verb “to include” or “to comprise” and conjugate forms thereof does not exclude the presence of elements or steps other than those stated in a claim.

In the claims no reference sign between parentheses should be interpreted as a limitation of the claim.

1. A sealed and thermally-insulating tank intended to be installed in a supporting structure to store liquefied gas, comprising:
a first tank wall and a second tank wall joining at a level of an edge and respectively extending in a first median plane and a second median plane inclined relative to one another so as to form at a level of a junction between the first tank wall and the second tank wall a corner zone,
the first tank wall including in a first direction of thickness of the first tank wall from an exterior to an interior of the sealed and thermally-insulating tank:
a first underlying thermally-insulating barrier and a first underlying sealed membrane supported by the first underlying thermally-insulating barrier, and
a first thermally-insulating barrier and first sealed membrane supported by the first thermally-insulating barrier
the second tank wall including in a second direction of thickness of the second tank wall, from the exterior to the interior of the sealed and thermally-insulating tank:
a second underlying thermally-insulating barrier and a second underlying sealed membrane supported by the second underlying thermally-insulating barrier, and
a second thermally-insulating barrier and a second sealed membrane supported by the second thermally-insulating barrier,
the first sealed membrane and the second sealed membrane being fixed in a sealed manner to a corner anchor strip along the edge
a corner anchor rod extending in a direction that crosses a direction of the edge formed between the first tank wall and the second tank wall in an extension plane passing through the edge inclined at a non-zero angle relative to each of the first tank wall and the second tank wall,
an anchor bar extending in a plane perpendicular to a direction of the corner anchor rod and anchored to a support, the support being an element of the underlying sealed membrane,
a first end of the corner anchor rod cooperating with the anchor bar and a second end of the corner anchor rod cooperating with the corner anchor strip to transmit a traction force between the corner anchor strip and the support.

2. The sealed and thermally-insulating tank according to claim 1, wherein the corner anchor element further includes a blocking part that cooperates with the second end of the corner anchor rod to block the second end of the corner anchor rod on the corner anchor strip.

3. The sealed and thermally-insulating tank according to claim 2, wherein the blocking part of the corner angle element includes a corner abutment part having two lateral faces adapted to be pressed against the corner anchor strip and a main face through which the second end of the corner anchor rod projects.

4. The sealed and thermally-insulating tank according to claim 3, wherein the second end of the corner anchor rod receives a blocking nut that axially blocks the corner abutment part and a sealed protective cover that covers the second end entirely.

5. The sealed and thermally-insulating tank according to claim 4, wherein the second end of the corner anchor rod further receives at least one compressible clamping washer disposed between the blocking nut and the corner abutment part.

6. The sealed and thermally-insulating tank according to claim 5, wherein the second end of the corner anchor rod further receives a spacer including:
a plane base disposed between the blocking nut and the at least one compressible clamping washer, and
a sleeve that receives the corner anchor rod and passes through a central opening in the at least one compressible clamping washer

7. The sealed and thermally-insulating tank according to claim 1, wherein a central part of the anchor bar includes a through-orifice that receives the corner anchor rod.

8. The sealed and thermally-insulating tank according to claim 1, wherein the first end of the corner anchor rod extends beyond the anchor bar in such a manner as to prevent contact with the support.

9. The sealed and thermally-insulating tank according to claim 1, wherein the corner anchor rod is at least partly threaded and fixed against the anchor bar by a nut welded to the anchor bar on an exterior face of the anchor bar facing the support.

10. The sealed and thermally-insulating tank according to claim 1, wherein each underlying sealed membrane is a primary sealed membrane, wherein each of the first tank wall and the second tank wall further includes a secondary sealed membrane disposed between the primary sealed membrane and the supporting structure, the underlying thermally-insulating barrier including a secondary thermally-insulating barrier disposed between the secondary sealed membrane and the supporting structure and a primary thermally-insulating barrier disposed between the secondary sealed membrane and the primary sealed membrane.

11. The sealed and thermally-insulating tank according to claim 1, wherein the first tank wall and the second tank wall form between them a tank corner in the extension plane of the corner anchor rod, the direction of the corner anchor rod dividing the tank corner into two equal angles.

12. A method of manufacturing the sealed and thermally-insulating tank according to claim 6, wherein the second end of the corner anchor rod to cooperates with the corner anchor strip in such a manner as to transmit a traction force between the corner anchor strip and the support, wherein the at least one compressible clamping washer is compressed by a dedicated tool including:
a frame with two arms oriented toward one another in such a manner as to form an angle identical to that between the first tank wall (101) and the second tank wall and connected by a central part of the frame,
the central part including a central orifice allowing the corner anchor rod to pass through it, each of the arms of the frame being pressed and blocked against one of the walls of the corner anchor strip in such a manner as to block the frame on the corner anchor strip,
a piston cylinder supported by the central part of the frame and including a central opening allowing the corner anchor rod to pass through it,
a bearing part having a shape adapted to compress said the at least one compressible clamping washer while allowing the tightening of the blocking nut by the method comprising;
the frame of the dedicated tool is fixed to the corner anchor strip,
the piston cylinder is actuated to bear on the bearing part, which compresses said the at least one compressible clamping washer,
the blocking nut is tightened through an access opening of the bearing part.

13. A ship for transporting a cold liquid product, the ship including a double hull and the sealed and thermally-insulating tank according to claim 1 disposed in the double hull.

14. A transfer system for a cold liquid product, the transfer system including the ship according to claim 13, insulated pipes arranged in such a manner as to connect the sealed and thermally-insulating tank of the ship to a floating or onshore storage installation, and a pump for driving a flow of cold liquid product through the insulated pipes from or to the floating or onshore storage installation to or from the sealed and thermally-insulating tank of the ship.

15. A method of loading or off-loading a ship in which a cold liquid product is conveyed through insulated pipes from or to a floating or onshore storage installation to or from the sealed and thermally-insulating tank of the ship according to claim 13.
